(19) United States
(12) Patent Application Publication
(10) Pub. No.: US 2024/0215013 A1
(43) Pub. Date: Jun. 27, 2024

(54) TECHNIQUES FOR SHARED RADIO FREQUENCY COMMUNICATIONS OVER MULTIPLE FREQUENCY BANDS

(71) Applicant: QUALCOMM Incorporated, San Diego, CA (US)

(72) Inventors: Yiqing CAO, Beijing (CN); Peter GAAL, San Diego, CA (US); Alberto RICO ALVARINO, San Diego, CA (US); Juan MONTOJO, San Diego, CA (US); Wanshi CHEN, San Diego, CA (US); Kazuki TAKEDA, Minato-ku (JP); Bin HAN, Beijing (CN); Yan LI, Beijing (CN); Zhimin DU, Beijing (CN); Kefeng ZHANG, Beijing (CN)

(21) Appl. No.: 18/557,776

(22) PCT Filed: Jul. 23, 2021
(86) PCT No.: PCT/CN2021/108167

§ 371 Date: Oct. 27, 2023

(51) Int. Cl. H04W 72/1263; H04W 24/10; H04W 72/51

(52) U.S. Cl. CPC H04W 72/1263; H04W 24/10; H04W 72/51

(57) ABSTRACT

Various aspects of the present disclosure generally relate to wireless communication. In some aspects, a user equipment (UE) may transmit, to a base station. UE capability information including a first indication of a first capability of the UE for downlink reception in a plurality of frequency spectrum bands using a first radio frequency receive chain and a second indication of a second capability of the UE for uplink transmission in the plurality of frequency spectrum bands using a second radio frequency transmit chain. The UE may receive at least one of a measurement configuration associated with downlink reference signals for the plurality of frequency spectrum bands or a transmission configuration associated with uplink reference signals for the plurality of frequency spectrum bands. Numerous other aspects are described.

### FIELD OF THE DISCLOSURE

Aspects of the present disclosure generally relate to wireless communication and to techniques and apparatuses for shared radio frequency (RF) communications over multiple frequency bands.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, to a base station, UE capability information including a first indication of a first capability of the UE for downlink reception in a plurality of frequency spectrum bands using a first radio frequency (RF) receive (Rx) chain and a second indication of a second capability of the UE for uplink transmission in the plurality of frequency spectrum bands using a second RF transmit (Tx) chain. The method may include receiving at least one of a measurement configuration associated with downlink reference signals for the plurality of frequency spectrum bands or a transmission configuration associated with uplink reference signals for the plurality of frequency spectrum bands.

Some aspects described herein relate to a method of wireless communication performed by a base station. The method may include receiving, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The method may include transmitting, to the UE and based at least in part on the UE capability information, at least one of a measurement configuration associated with downlink reference signals for the plurality of frequency spectrum bands or a transmission configuration associated with uplink reference signals for the plurality of frequency spectrum bands.

Some aspects described herein relate to a UE for wireless communication. The user equipment may include a memory and one or more processors coupled to the memory. The one or more processors may be configured to transmit, to a base station, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The one or more processors may be configured to receive at least one of a measurement configuration associated with downlink reference signals for the plurality of frequency spectrum bands or a transmission configuration associated with uplink reference signals for the plurality of frequency spectrum bands.

Some aspects described herein relate to a base station for wireless communication. The base station may include a memory and one or more processors coupled to the memory. The one or more processors may be configured to receive, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The one or more processors may be configured to transmit, to the UE and based at least in part on the UE capability information, at least one of a measurement configuration associated with downlink reference signals for the plurality of frequency spectrum bands or a transmission configuration associated with uplink reference signals for the plurality of frequency spectrum bands.

Some aspects described herein relate to a non-transitory computer-readable medium that stores a set of instructions for wireless communication by a UE. The set of instructions, when executed by one or more processors of the UE, may cause the UE to transmit, to a base station, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The set of instructions, when executed by one or more processors of the UE, may cause the UE to receive at least one of a measurement configuration associated with downlink reference signals for the plurality of frequency spectrum bands or a transmission configuration associated with uplink reference signals for the plurality of frequency spectrum bands.

Some aspects described herein relate to a non-transitory computer-readable medium that stores a set of instructions for wireless communication by a base station. The set of instructions, when executed by one or more processors of the base station, may cause the base station to receive, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The set of instructions, when executed by one or more processors of the base station, may cause the base station to transmit, to the UE and based at least in part on the UE capability information, at least one of a measurement configuration associated with downlink reference signals for the plurality of frequency spectrum bands or a transmission configuration associated with uplink reference signals for the plurality of frequency spectrum bands.

Some aspects described herein relate to an apparatus for wireless communication. The apparatus may include means for transmitting, to a base station, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The apparatus may include means for receiving at least one of a measurement configuration associated with downlink reference signals for the plurality of frequency spectrum bands or a transmission configuration associated with uplink reference signals for the plurality of frequency spectrum bands.

Some aspects described herein relate to an apparatus for wireless communication. The apparatus may include means for receiving, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The apparatus may include means for transmitting, to the UE and based at least in part on the UE capability information, at least one of a measurement configuration associated with downlink reference signals for the plurality of frequency spectrum bands or a transmission configuration associated with uplink reference signals for the plurality of frequency spectrum bands.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating an example of a radio frequency (RF) transmit (Tx) chain and an RF receive (Rx) chain of a UE, in accordance with the present disclosure.

FIG. 5 is a diagram illustrating an example associated with shared RF communications over multiple frequency bands, in accordance with the present disclosure.

FIGS. 6-7 are diagrams illustrating example processes associated with shared RF communications over multiple frequency bands, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

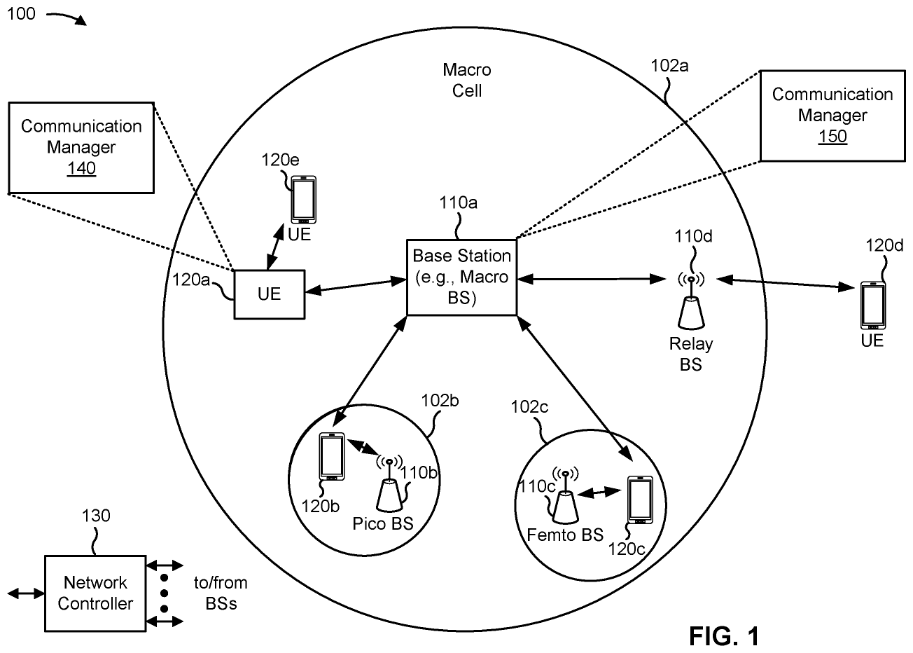

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a base station, UE capability information including a first indication of a first capability of the UE for downlink reception in a plurality of frequency spectrum bands using a same radio frequency (RF) receive (Rx) chain and a second indication of a second capability of the UE for uplink transmission in the plurality of frequency spectrum bands using a same RF transmit (Tx) chain; and receive, from the base station, at least one of a measurement configuration associated with downlink reference signals for the plurality of frequency spectrum bands or a transmission configuration associated with uplink reference signals for the plurality of frequency spectrum bands. Additionally, or alternatively, the communication manager 140 may perform one or more other operations described herein.

In some aspects, the base station 110 may include a communication manager 150. As described in more detail elsewhere herein, the communication manager 150 may receive, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain; and transmit, to the UE and based at least in part on the UE capability information, at least one of a measurement configuration associated with downlink reference signals for the plurality of frequency spectrum bands or a transmission configuration associated with uplink reference signals for the plurality of frequency spectrum bands. Additionally, or alternatively, the communication manager 150 may perform one or more other operations described herein.

As indicated above, FIG. 1 is provided as an example. Other examples may differ from what is described with regard to FIG. 1.

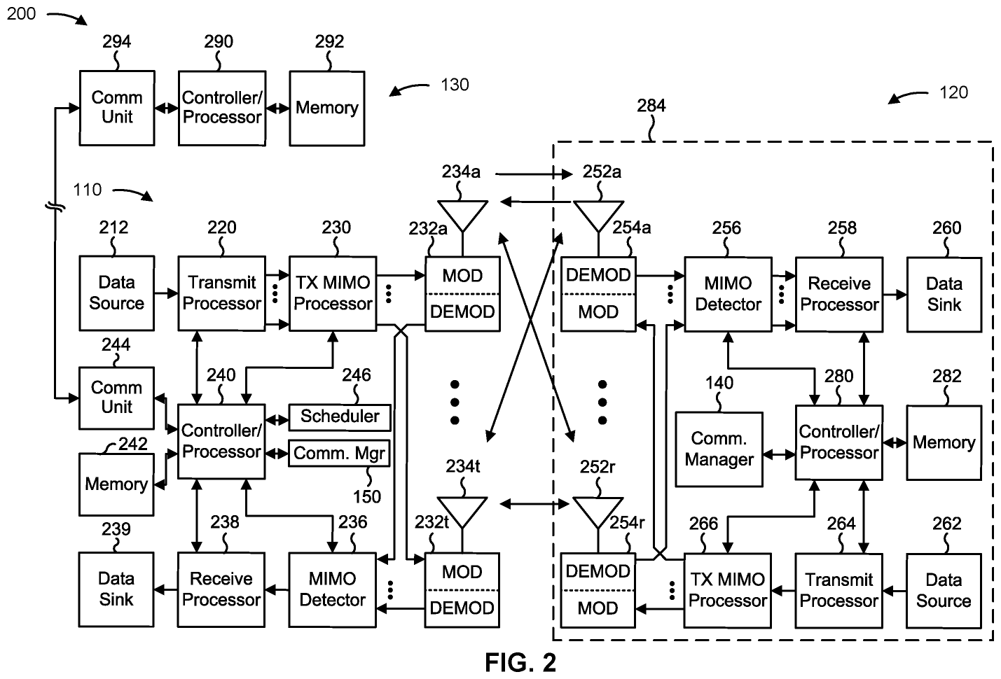

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥ 1). The UE 120 may be equipped with a set of antennas 252a through 252r, such as R antennas (R≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

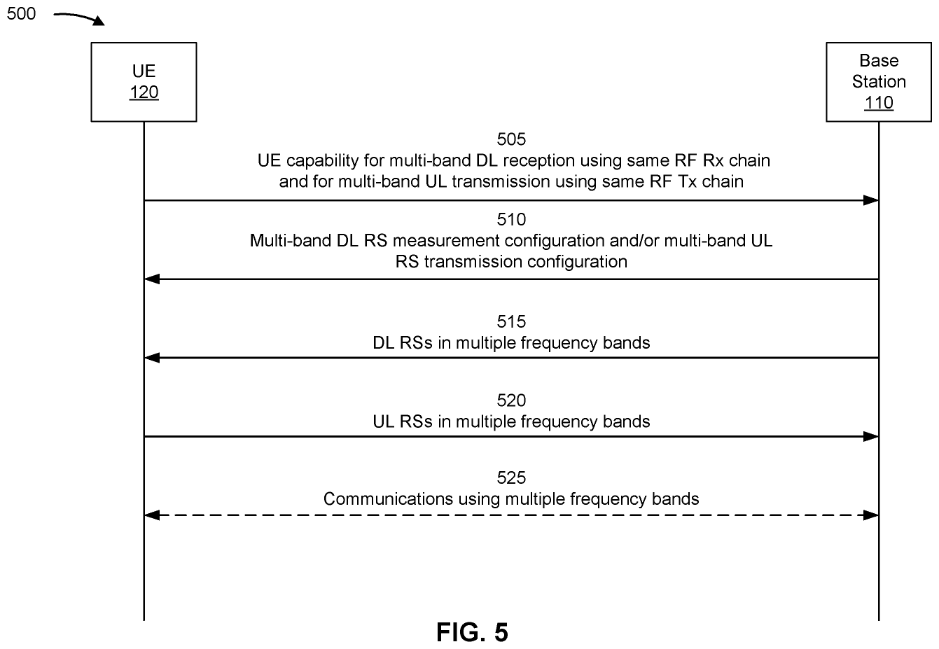

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

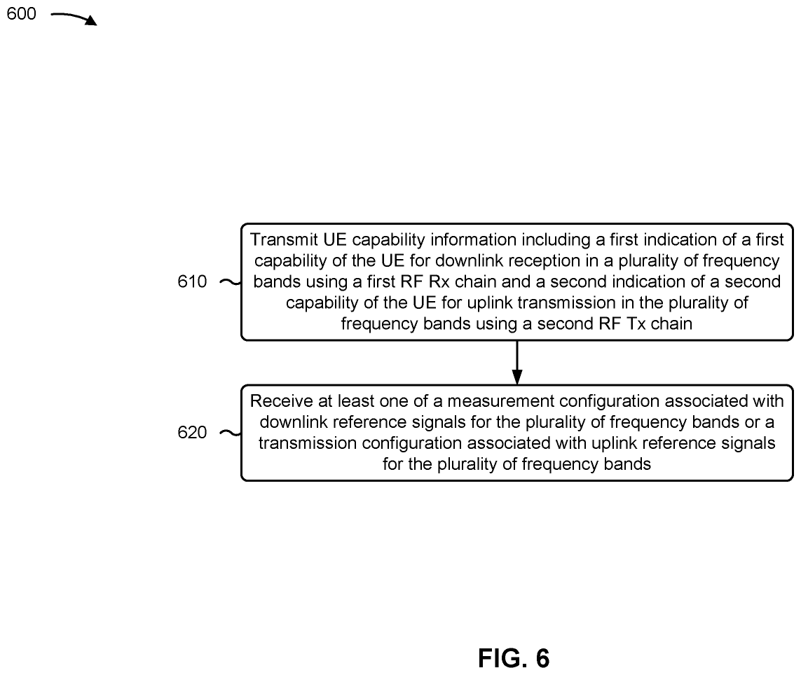

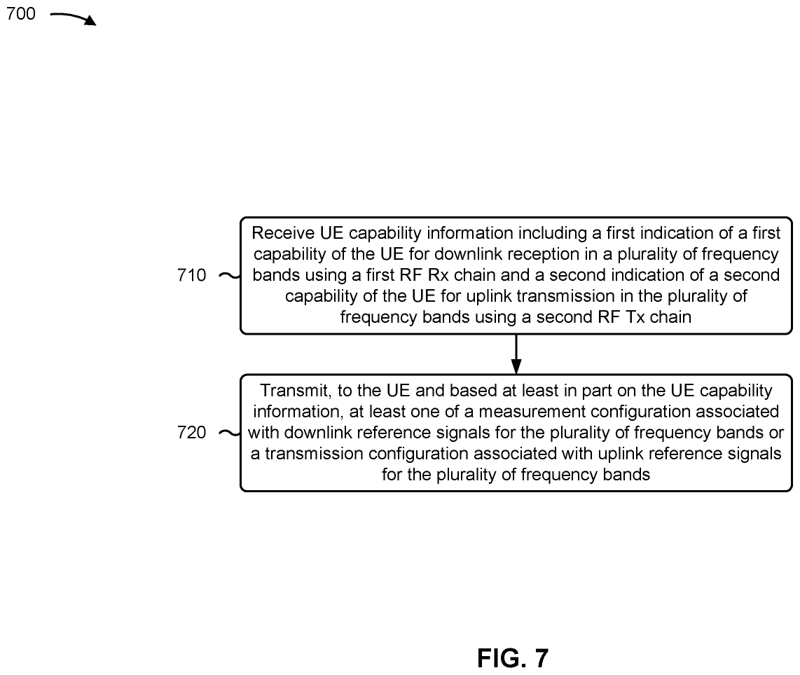

The controller/processor 240 of the base station 110, the controller/processor 280 of the UE 120, and/or any other component(s) of FIG. 2 may perform one or more techniques associated with shared RF communications over multiple frequency bands, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for transmitting, to a base station, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain; and/or means for receiving at least one of a measurement configuration associated with downlink reference signals for the plurality of frequency spectrum bands or a transmission configuration associated with uplink reference signals for the plurality of frequency spectrum bands. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for receiving, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain; and/or means for transmitting, to the UE and based at least in part on the UE capability information, at least one of a measurement configuration associated with downlink reference signals for the plurality of frequency spectrum bands or a transmission configuration associated with uplink reference signals for the plurality of frequency spectrum bands. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

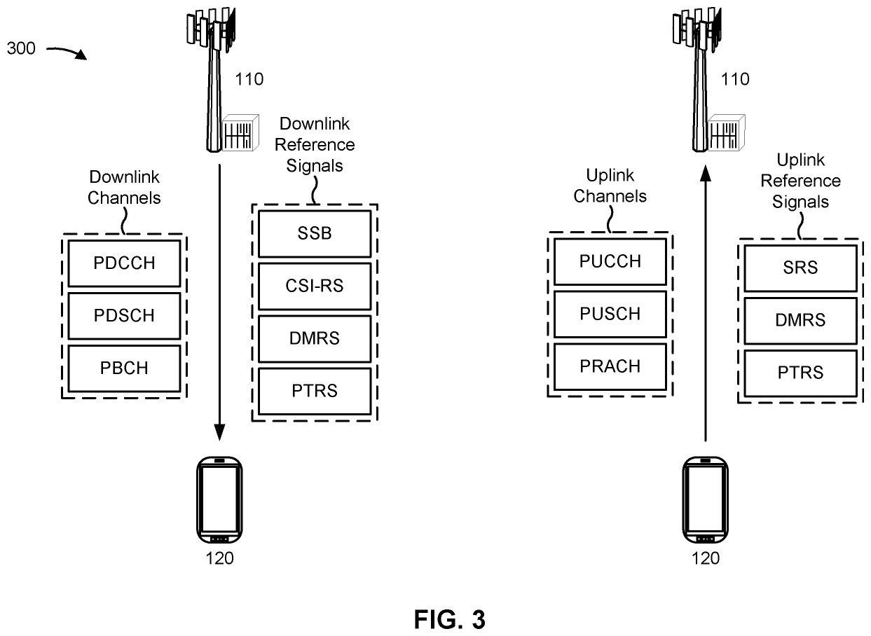

FIG. 3 is a diagram illustrating an example 300 of physical channels and reference signals in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some examples, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some examples, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random quadrature phase shift keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

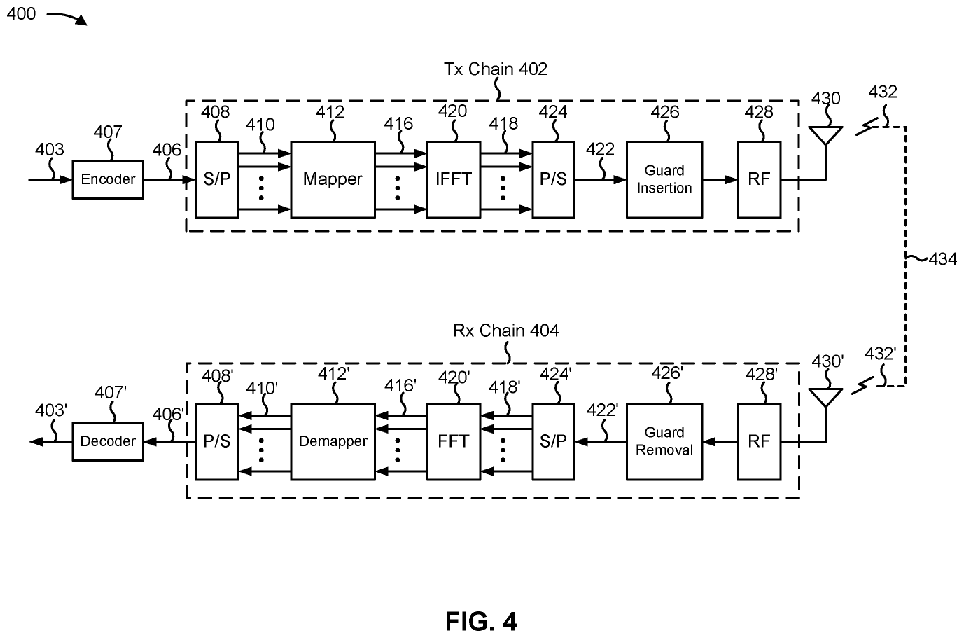

FIG. 4 is a diagram illustrating an example 400 of an RF Tx chain 402 and an RF Rx chain 404 of a UE 120, in accordance with the present disclosure. The RF Tx chain 402 may also be referred to as a “Tx chain,” and the RF Rx chain 404 may also be referred to as an “Rx chain.” In some examples, one or more components of Tx chain 402 may be implemented in transmit processor 264, TX MIMO processor 266, modem 254, and/or controller/processor 280, as described above in connection with FIG. 2. In some examples, Tx chain 402 may be implemented in UE 120 for transmitting data 406 (e.g., uplink data, an uplink reference signal, and/or uplink control information) to base station 110 on an uplink channel.

An encoder 407 may alter a signal (e.g., a bitstream) 403 into data 406. Data 406 to be transmitted is provided from encoder 407 as input to a serial-to-parallel (S/P) converter 408. In some examples, S/P converter 408 may split the transmission data into N parallel data streams 410.

The N parallel data streams 410 may then be provided as input to a mapper 412. Mapper 412 may map the N parallel data streams 410 onto N constellation points. The mapping may be done using a modulation constellation, such as binary phase-shift keying (BPSK), QPSK, 8 phase-shift keying (8PSK), quadrature amplitude modulation (QAM), etc. Thus, mapper 412 may output N parallel symbol streams 416, each symbol stream 416 corresponding to one of N orthogonal subcarriers of an inverse fast Fourier transform (IFFT) component 420. These N parallel symbol streams 416 are represented in the frequency domain and may be converted into N parallel time domain sample streams 418 by IFFT component 420.

In some examples, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Nep (the number of guard samples per OFDM symbol)+N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of guard insertion component 426 may then be upconverted to a desired transmit frequency band by an RF front end 428. An antenna 430 may then transmit the resulting signal 432. In some examples, Tx chain 402 (e.g., RF front end 428) may be tuned to a certain frequency range in order to transmit the signal 432 in the desired transmit frequency band. In some cases, a Tx chain 402 of a UE 120 may require RF re-tuning to a different frequency range in order to transmit signals in different frequency bands or component carriers. In some cases, a Tx chain 402 of a UE 120 may be capable covering multiple frequency bands or component carriers. In this case, the Tx chain 402 may be capable of transmitting signals on different frequency bands or component carriers without performing RF re-tuning between transmissions on different frequency bands or component carriers. In some cases, a Tx chain 402 of a UE 120 may be capable of simultaneously transmitting on multiple frequency bands or component carriers.

In some examples, Rx chain 404 may utilize OFDM/OFDMA. In some examples, one or more components of Rx chain 404 may be implemented in receive processor 258, MIMO detector 256, modem 254, and/or controller/processor 280, as described above in connection with FIG. 2. In some examples, Rx chain 404 may be implemented in UE 120 for receiving data 406 (e.g., downlink data, a downlink reference signal, and/or downlink control information) from base station 110 on a downlink channel.

A transmitted signal 432 is shown traveling over a wireless channel 434 from Tx chain 402 to Rx chain 404. When a signal 432′ is received by an antenna 430′, the received signal 432′ may be downconverted to a baseband signal by an RF front end 428′. A guard removal component 426′ may then remove the guard interval that was inserted between OFDM/OFDMA symbols by guard insertion component 426.

The output of guard removal component 426′ may be provided to an S/P converter 424′. The output may include an OFDM/OFDMA symbol stream 422′, and S/P converter 424′ may divide the OFDM/OFDMA symbol stream 422′ into N parallel time-domain symbol streams 418′, each of which corresponds to one of the N orthogonal subcarriers. A fast Fourier transform (FFT) component 420′ may convert the N parallel time-domain symbol streams 418′ into the frequency domain and output N parallel frequency-domain symbol streams 416′.

A demapper 412′ may perform the inverse of the symbol mapping operation that was performed by mapper 412, thereby outputting N parallel data streams 410′. A P/S converter 408′ may combine the N parallel data streams 410′ into a single data stream 406′. Ideally, data stream 406′ corresponds to data 406 that was provided as input to Tx chain 402. Data stream 406′ may be decoded into a decoded data stream 403′ by decoder 407′.

In some examples, Rx chain 404 may be tuned to a certain frequency range in order to receive the signal 432′ on the frequency band on which the signal 432′ was transmitted. In some cases, an Rx chain 404 of a UE 120 may require RF re-tuning to a different frequency range in order to receive signals in different frequency bands or component carriers. In some cases, an Rx chain 404 of a UE 120 may be capable covering multiple frequency bands or component carriers. In this case, the Rx chain 404 may be capable of receiving signals on different frequency bands or component carriers without performing RF re-tuning between reception on different frequency bands or component carriers. In some cases, an Rx chain 404 of a UE 120 may be capable of simultaneously receiving signals on multiple frequency bands or component carriers.

As indicated above, FIG. 4 is provided as an example. Other examples may differ from what is described with regard to FIG. 4.

Increased flexibility for RF communications on multiple component carriers or frequency bands may be beneficial in a wireless communication network. For example, flexible configurations for sharing or distributing RF communications (e.g., downlink and/or uplink communications) on multiple frequency bands may result in reduced interference, increased network speed, and/or reduced traffic latency, among other examples. However, while some UEs can cover multiple frequency bands using a single Tx chain or Rx chain, other UEs may require time to perform RF re-tuning between transmissions or receptions in different frequency bands. In some cases, a base station may configure a switching gap between communications (e.g., uplink and/or downlink communications) in different frequency bands. However, this may increase traffic latency and reduce the flexibility of configurations for sharing RF communications on multiple frequency bands for UEs that can cover the multiple frequency bands using a single Tx or Rx chain.

Some techniques and apparatuses described herein enable a UE to transmit, to a base station, UE capability information including a first indication of a first UE capability for downlink reception in multiple frequency bands using a same/single RF Rx chain and a second indication of a second UE capability for uplink transmission in multiple frequency bands using a same/single RF Tx chain. The base station may configure at least one of a measurement configuration associated with downlink reference signals for multiple frequency bands or a transmission configuration associated with uplink reference signals for multiple frequency bands based at least in part on the UE capability information, and the base station may transmit the measurement configuration and/or the transmission configuration to the UE. The UE may receive the measurement configuration and/or the transmission configuration, and the UE may measure the downlink reference signals for the multiple frequency bands scheduled by the measurement configuration and/or transmit the uplink reference signals for the multiple frequency bands scheduled by the transmission configuration. As a result, the UE may be configured for communications in multiple frequency bands based at least in part on the UE capability to receive downlink communications in multiple frequency bands without performing RF re-tuning and/or the UE capability to transmit uplink communications in multiple frequency bands without performing RF re-tuning. This may result in decreased traffic latency and increased flexibility of configuring UEs for sharing communications on multiple frequency bands.

Furthermore, the joint scheduling of downlink reference signals for multiple frequency bands and/or uplink reference signals for multiple frequency bands may decrease the time associated with channel estimation when switching between different frequency bands, and thus decrease traffic latency and increase network speed.

FIG. 5 is a diagram illustrating an example 500 associated with shared RF communications over multiple frequency bands, in accordance with the present disclosure. As shown in FIG. 5, example 500 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink.

As shown in FIG. 5, and by reference number 505, the UE 120 may transmit, to the base station 110, UE capability information. For example, the UE capability information may be included in a UE capability report. The UE capability information may indicate the UE capability (e.g., the capability of the UE 120) for multi-band downlink reception using a same RF Rx chain and the UE capability for multi-band uplink reception using a same RF Tx chain. The indication of the UE capability for multi-band downlink reception using a same RF Rx chain may be an indication of a capability of the UE 120 for downlink reception in multiple frequency spectrum bands using the same RF Rx chain (e.g., without performing re-tuning of the RF Rx chain between downlink receptions in different frequency bands). “Frequency spectrum bands” and “frequency bands” may be used interchangeably herein. The indication of the UE capability for multi-band uplink transmission using a same RF Tx chain may be an indication of a capability of the UE 120 for uplink transmission in multiple frequency bands using the same RF Tx chain (e.g., without performing re-tuning of the RF Tx chain between transmissions in different frequency bands). In some aspects, separate UE capabilities may be defined for multi-band downlink reception and for multi-band uplink transmission, and the UE capability information may include separate indications for the UE capability for multi-band downlink reception and the UE capability for multi-band uplink transmission. For example, the UE capability information may include a first indication of a first capability of the UE for downlink reception in a plurality of frequency bands using a same RF Rx chain (e.g., a first RF Rx chain) and a second indication of a second capability of the UE for uplink transmission in a plurality of frequency bands using a same RF Tx chain (e.g., a second RF Tx chain).

In some aspects, the first indication may include an indication of whether the UE 120 is capable of receiving downlink communications in different frequency bands without a switching gap (e.g., for RF re-tuning) between the downlink communications in the different frequency bands. Additionally, or alternatively, the first indication may include an indication of whether the UE 120 is capable of simultaneously receiving downlink communications in different frequency bands.

In some aspects, the first indication of the first UE capability may include an inter-frequency measurement indication (e.g., “interFrequencyMeas-NoGap”) that indicates a capability of the UE 120 for performing inter-frequency SSB-based measurements without measurement gaps for SSBs within an active bandwidth part (BWP). In this case, the UE 120 may leverage the inter-frequency measurement indication (e.g., “interFrequencyMeas-NoGap”) to also indicate whether or not the UE 120 is capable of downlink reception in multiple frequency bands using the same RF Rx chain. For example, the inter-frequency measurement indication (e.g., “interFrequencyMeas-NoGap”) may be set as a first value (e.g., 1) to indicate that the UE 120 is capable of performing the inter-frequency SSB-based measurements and capable of multi-band downlink reception using the same RF Rx chain, or a second value (e.g., 0) to indicate that the UE 120 is not capable performing the inter-frequency SSB-based measurements and not capable of multi-band downlink reception using the same RF Rx chain. In a case in which the inter-frequency measurement indication (e.g., “interFrequencyMeas-NoGap”) indicates that the UE 120 is capable of downlink reception in multiple frequency bands using the same RF Rx chain, the first indication may also include an indication of one of more frequency band combinations and/or a frequency range. For example, the first indication may include a list of frequency band combinations for which the UE 120 is capable of downlink reception using the same RF Rx chain (e.g., without performing RF re-tuning). Additionally, or alternatively, the first indication may include an indication of a frequency range for frequency bands for which the UE 120 is capable of downlink reception using the same RF Rx chain.

In some aspects, the first indication may include an indication of a per-frequency band combination downlink reception capability of the UE 120. For example, the first indication may include, for each of one or more different combinations of frequency bands, a respective indication of a capability of the UE 120 for downlink reception in that combination of frequency bands using the same RF Rx chain. In this case, multiple different frequency band combinations may be configured, and each configured frequency band combination may be associated with a respective index value. Each frequency band combination may include two or more frequency bands. The first indication may include a respective UE capability indication for each of the index values associated with the configured frequency band combinations. In some aspects, the respective indication, for each frequency band combination, may indicate that the UE 120 is capable of receiving downlink communications from the frequency bands in that frequency band combination without a switching gap to perform RF re-tuning. In some aspects, the respective indication, for each frequency band combination, may indicate that the UE 120 is capable of simultaneously receiving downlink communications from the frequency bands in that frequency band combination using the same RF Rx chain (e.g., using a single RF Rx chain). For example, the per-frequency band combination downlink reception capability indication may be referred to as “SimultaneousRxwithSingleRx.”

In some aspects, the second indication for the second UE 120 capability for multi-band uplink transmission using the same RF Tx chain may include an indication of whether the UE 120 is capable of transmitting communications in different frequency bands without a switching gap (e.g., for RF re-tuning) between the uplink communications in the different frequency bands. Additionally, or alternatively, the second indication may include an indication of whether the UE 120 is capable of simultaneously transmitting uplink communications in different frequency bands.

In some aspects, the second indication may include an indication of a per-frequency band combination uplink transmission capability of the UE 120. For example, the second indication may include, for each of one or more different combinations of frequency bands, a respective indication of a capability of the UE 120 for uplink transmission in that combination of frequency bands using the same RF Tx chain. In this case, multiple different frequency band combinations may be configured, and each configured frequency band combination may be associated with a respective index value. Each frequency band combination may include two or more frequency bands. The second indication may include a respective UE capability indication for each of the index values associated with the configured frequency band combinations. In some aspects, the respective indication, for each frequency band combination, may indicate that the UE 120 is capable of transmitting uplink communications from the frequency bands in that frequency band combination without a switching gap to perform RF re-tuning between the uplink transmissions. In some aspects, the respective indication, for each frequency band combination, may indicate that the UE 120 is capable of simultaneously transmitting communications from the frequency bands in that frequency band combination using the same RF Tx chain (e.g., using a single RF Tx chain). For example, the per-frequency band combination uplink transmission capability indication may be referred to as “SimultaneousTxwithSingleTx.”

As further shown in FIG. 5, and by reference number 510, the base station 110 may transmit, to the UE 120, a multi-band downlink reference signal measurement configuration and/or a multi-band uplink reference signal transmission configuration. The base station 110 may receive the UE capability information from the UE 120, and the base station 110 may configure the multi-band downlink reference signal measurement configuration and/or the multi-band uplink reference signal transmission configuration based at least in part on the UE capability information. In some aspects, the base station 110 may schedule transmission, to the UE 120, of downlink reference signals (e.g., CSI-RSs and/or SSBs) in multiple frequency bands based at least in part on the first indication of the first UE capability received from the UE 120. In some aspects, the base station 110 may schedule transmission, by the UE 120, of uplink reference signals based at least in part on the second indication of the second UE capability received from the UE 120. In some aspects, the base station 110 may transmit the multi-band downlink reference signal measurement configuration and/or the multi-band uplink reference signal transmission configuration to the UE 120 via one or more radio resource control (RRC) messages.

The multi-band downlink reference signal measurement configuration may be a measurement configuration associated with downlink reference signals for multiple frequency bands. In some aspects, the measurement configuration may jointly schedule measurements of downlink reference signals (e.g., CSI-RSs and/or SSBs) in a plurality of frequency bands for the UE 120. The measurement configuration for the downlink reference signals may be based at least in part on the UE capability information. In some aspects, based at least in part on the first indication of the first UE capability indicating that the UE 120 is capable of downlink reception in a combination of frequency bands using the same RF Rx chain, the measurement configuration may jointly schedule the measurements of the downlink reference signals (e.g., CSI-RSs and/or SSBs) with no measurement gap between the downlink reference signals transmitted in different frequency bands in the combination of frequency bands. In some aspects, based at least in part on the first indication of the first UE capability indicating that the UE 120 is capable of simultaneously receiving downlink communications in a combination of frequency bands using the same RF Rx chain, the measurement configuration may jointly schedule simultaneous transmission of downlink reference signals (e.g., CSI-RSs and/or SSBs) on different frequency bands in the combination of frequency bands. In this case, the measurement configuration may configure the UE 120 to measure multi-band SSB and/or CSI-RS transmissions.

In some aspects, the multi-band downlink reference signal measurement configuration may include a same measurement configuration for multiple different frequency bands. In some aspects, the multi-band downlink reference signal measurement configuration may include different measurement configurations for different frequency bands. In some aspects, the measurement configuration may include the same downlink reference signal configuration for downlink reference signals scheduled on different frequency bands. For example, the measurement configuration may include the same reference signal configuration for a first downlink reference signal scheduled on a first frequency band and a second reference signal scheduled on a second frequency band. In some aspects, CSI-RSs scheduled on different frequency bands may be configured with the same antenna port number and/or the same reference signal pattern.

The multi-band uplink reference signal transmission configuration may be a transmission configuration associated with uplink reference signals for multiple frequency bands. In some aspects, the transmission configuration may jointly schedule transmissions of uplink reference signals (e.g., SRSs) in a plurality of frequency bands for the UE 120. The transmission configuration for the uplink reference signals may be based at least in part on the UE capability information. In some aspects, based at least in part on the second indication of the second UE capability indicating that the UE 120 is capable of uplink transmission in a combination of frequency bands using the same RF Tx chain, the transmission configuration may jointly schedule the transmissions of the uplink reference signals (e.g., SRSs) with no switching gap between the uplink reference signals transmitted in different frequency bands in the combination of frequency bands. In some aspects, based at least in part on the second indication of the second UE capability indicating that the UE 120 is capable of simultaneously transmitting uplink communications in a combination of frequency bands using the same RF Tx chain, the measurement configuration may jointly schedule simultaneous transmissions of uplink reference signals (e.g., SRSs), by the UE 120, on different frequency bands in the combination of frequency bands.

In some aspects, the transmission configuration may include the same uplink reference signal configuration for uplink reference signals scheduled on different frequency bands. For example, in some aspects, SRSs scheduled on different frequency bands may be configured with the same antenna port number and/or the same reference signal pattern. In some aspects, the transmission configuration may include different uplink reference signal configurations for uplink reference signals scheduled on different frequency bands. For example, in some aspects, SRSs scheduled on different frequency bands may be configured with different antenna port numbers.

As further shown in FIG. 5, and by reference number 515, the base station 110 may transmit, to the UE 120, downlink reference signals (e.g., CSI-RSs and/or SSBs) in multiple frequency bands based at least in part on the multi-band downlink reference signal measurement configuration. The UE 120, based at least in part on the multi-band downlink reference signal measurement configuration received by the base station 110, may receive the scheduled downlink reference signals (e.g., CSI-RSs and/or SSBs) in the multiple frequency bands and perform measurements of the downlink reference signals in the multiple frequency bands.

In some aspects, the measurement configuration may jointly schedule CSI-RSs on multiple frequency bands. In this case, based at least in part on the measurement configuration, the UE 120 may measure the CSI-RSs to perform channel estimation for the multiple frequency bands, and the UE 120 may transmit channel estimation parameters for the multiple frequency bands to the base station 110. The base station 110 may determine whether to switch one or more downlink communications between different frequency bands based at least in part on the channel estimation parameters for the multiple frequency bands. In addition, the channel estimation for multiple frequency bands may reduce a time associated with performing channel estimation when downlink communications to the UE 120 are switched between different frequency bands.

As further shown in FIG. 5, and by reference number 520, the UE 120 may transmit, to the base station 110, uplink reference signals (e.g., SRSs) in multiple frequency bands based at least in part on the multi-band uplink reference signal transmission configuration. The UE 120, based at least in part on the multi-band uplink reference signal transmission configuration received from the base station 110, may transmit the scheduled uplink reference signals (e.g., SRSs) in the multiple frequency bands. The base station 110 may receive the uplink reference signals transmitted in the multiple frequency bands, and the base station 110 may perform measurements of the uplink reference signals in the multiple frequency bands.

In some aspects, the transmission configuration may jointly schedule transmission of SRSs on multiple frequency bands by the UE 120. In this case, based at least in part on the transmission configuration, the UE 120 may transmit the SRSs to the base station 110 in the multiple frequency bands. The base station 110 may receive and measure the SRSs, and the base station 110 perform channel estimation for the multiple frequency bands based at least in part on the SRS measurements. In some aspects, the base station 110 may determine whether to switch one or more downlink communications between different frequency bands based at least in part on the channel estimation for the multiple frequency bands. In addition, the channel estimation for multiple frequency bands may reduce a time associated with performing channel estimation when uplink communications from the UE 120 are switched between different frequency bands.

As further shown in FIG. 5, and by reference number 525, the UE 120 and the base station 110 may communicate using multiple frequency bands. In some aspects, the base station 110 may transmit one or more downlink communications using multiple frequency bands to the UE 120, and the UE 120 may receive the one or more downlink communications using the multiple frequency bands. In some aspects, the base station 110 may schedule one or more downlink communications that switch between multiple frequency bands based at least in part on the UE capability information (e.g., the first indication of the first UE capability). For example, the base station 110 may schedule a downlink communication that shares and/or switches between multiple frequency bands for which the UE 120 is capable of receiving using the same RF Rx chain based at least in part on the first indication of the first UE capability. In some aspects, the base station 110 may select the frequency bands for the one or more downlink communications based at least in part on the channel estimation parameters for different frequency bands received from the UE 120 in connection with the downlink reference signals (e.g., CSI-RSs) configured in the measurement configuration. In some aspects, the base station 110 may configure the scheduled downlink communications and the frequency bands for the downlink communications, for example in an RRC message transmitted to the UE 120. In some aspects, the base station 110 may schedule the downlink communications using the multiple frequency bands via DCI and/or a medium access control (MAC) control element (MAC-CE) transmitted to the UE 120.

In some aspects, the UE 120 may transmit one or more uplink communications using multiple frequency bands to the base station 110, and the base station 110 may receive the one or more uplink communications using the multiple frequency bands. In some aspects, the base station 110 may schedule one or more uplink communications that switch between multiple frequency bands based at least in part on the UE capability information (e.g., the second indication of the second UE capability). For example, the base station 110 may schedule an uplink communication that shares and/or switches between multiple frequency bands on which the UE 120 is capable of transmitting using the same RF Tx chain based at least in part on the second indication of the second UE capability. In some aspects, the base station 110 may select the frequency bands for the one or more uplink communications based at least in part on the channel estimation performed in connection with the uplink reference signals (e.g., SRSs) configured in the transmission configuration.

As described above, the UE 120 may transmit, to the base station 110, UE capability information including a first indication of a first UE capability for multi-band downlink reception using a same RF Rx chain and a second indication of a second UE capability for multi-band uplink transmission using a same RF Tx chain. The base station 110 may configure a measurement configuration that schedules downlink reference signals for multiple frequency bands and/or a transmission configuration associated that schedules uplink reference signals for multiple frequency bands based at least in part on the UE capability information, and the base station 110 may transmit the measurement configuration and/or the transmission configuration to the UE 120. The UE 120 may receive the measurement configuration and/or the transmission configuration, and the UE 120 may measure the downlink reference signals for the multiple frequency bands scheduled by the measurement configuration and/or transmit the uplink reference signals for the multiple frequency bands scheduled by the transmission configuration. As a result, the UE 120 may be configured for communications in multiple frequency bands based at least in part on the UE capability to receive downlink communications in multiple frequency bands without performing RF re-tuning and/or the UE capability to transmit uplink communications in multiple frequency bands without performing RF re-tuning. This may result in decreased traffic latency and increased flexibility of configuring UEs for sharing communications on multiple frequency bands. Furthermore, the joint scheduling of downlink reference signals for multiple frequency bands and/or uplink reference signals for multiple frequency bands may decrease the time associated with channel estimation when switching between different frequency bands, and thus decrease traffic latency and increase network speed

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with techniques for shared radio frequency communications.

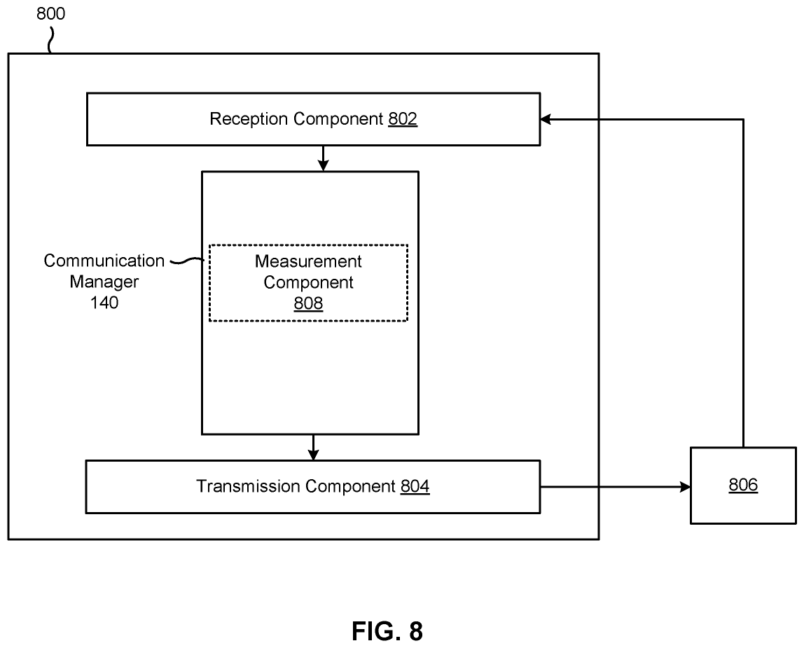

As shown in FIG. 6, in some aspects, process 600 may include transmitting, to a base station, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain (block 610). For example, the UE (e.g., using communication manager 140 and/or transmission component 804, depicted in FIG. 8) may transmit, to a base station, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain, as described above.

As further shown in FIG. 6, in some aspects, process 600 may include receiving at least one of a measurement configuration associated with downlink reference signals for the plurality of frequency spectrum bands or a transmission configuration associated with uplink reference signals for the plurality of frequency spectrum bands (block 620). For example, the UE (e.g., using communication manager 140 and/or reception component 802, depicted in FIG. 8) may receive at least one of a measurement configuration associated with downlink reference signals for the plurality of frequency spectrum bands or a transmission configuration associated with uplink reference signals for the plurality of frequency spectrum bands, as described above.

Process 600 may include additional aspects, such as any single aspect or any combination of aspects described below and/or in connection with one or more other processes described elsewhere herein.

In a first aspect, the first indication includes an indication of a capability of the UE to receive downlink communications in different frequency spectrum bands of the plurality of frequency spectrum bands without a switching gap between the downlink communications in the different frequency spectrum bands, and the second indication includes an indication of a capability of the UE to transmit uplink communications in the different frequency spectrum bands of the plurality of frequency spectrum bands without a switching gap between the uplink communications in the different frequency spectrum bands.

In a second aspect, alone or in combination with the first aspect, the first indication includes an indication of a capability of the UE to simultaneously receive downlink communications in different frequency spectrum bands of the plurality of frequency spectrum bands, and the second indication includes an indication of a capability of the UE to simultaneously transmit uplink communications in the different frequency spectrum bands of the plurality of frequency spectrum bands.

In a third aspect, alone or in combination with one or more of the first and second aspects, the first indication includes an inter-frequency measurement indication that indicates a capability of the UE for performing inter-frequency SSB based measurements without measurement gaps for SSBs within an active BWP, and the inter-frequency measurement indication further indicates the capability of the UE for downlink reception in the plurality of frequency spectrum bands using the first RF Rx chain.

In a fourth aspect, alone or in combination with one or more of the first through third aspects, the inter-frequency measurement indication indicates that the UE is capable of downlink reception in the plurality of frequency spectrum bands using the first RF Rx chain, and the first indication further includes at least one of an indication of one or more combinations of frequency spectrum bands in the plurality of frequency spectrum bands for which the UE is capable of downlink reception using the first RF Rx chain, or an indication of a frequency range for frequency spectrum bands in the plurality of frequency spectrum bands for which the UE is capable of downlink reception using the first RF Rx chain.

In a fifth aspect, alone or in combination with one or more of the first through fourth aspects, the first indication includes, for each of one or more different combinations of frequency spectrum bands in the plurality of frequency spectrum bands, a respective indication of a capability of the UE for downlink reception in that combination of frequency spectrum bands using the first RF Rx chain.

In a sixth aspect, alone or in combination with one or more of the first through fifth aspects, the second indication includes, for each of one or more different combinations of frequency spectrum bands in the plurality of frequency spectrum bands, a respective indication of a capability of the UE for uplink transmission in that combination of frequency spectrum bands using the second RF Tx chain.

In a seventh aspect, alone or in combination with one or more of the first through sixth aspects, the measurement configuration jointly schedules measurements of the downlink reference signals on the plurality of frequency spectrum bands.

In an eighth aspect, alone or in combination with one or more of the first through seventh aspects, based at least in part on the first indication indicating that the UE is capable of downlink reception in the plurality of frequency spectrum bands using the first RF Rx chain, the measurement configuration jointly schedules the measurements of the downlink reference signals on the plurality of frequency spectrum bands with no measurement gap between the downlink reference signals on different frequency spectrum bands of the plurality of frequency spectrum bands.

In a ninth aspect, alone or in combination with one or more of the first through eighth aspects, the measurement configuration includes a same reference signal configuration for a first downlink reference signal scheduled on a first frequency band of the plurality of frequency spectrum bands and a second downlink reference signal scheduled on a second frequency band of the plurality of frequency spectrum bands.

In a tenth aspect, alone or in combination with one or more of the first through ninth aspects, the transmission configuration jointly schedules transmissions of the uplink reference signals on the plurality of frequency spectrum bands.

In an eleventh aspect, alone or in combination with one or more of the first through tenth aspects, based at least in part on the second indication indicating that the UE is capable of uplink transmission in the plurality of frequency spectrum bands using the second RF Tx chain, the configuration jointly schedules the transmissions of the uplink reference signals on the plurality of frequency spectrum bands with no switching gap between the uplink reference signals on different frequency spectrum bands of the plurality of frequency spectrum bands.

In a twelfth aspect, alone or in combination with one or more of the first through eleventh aspects, the measurement configuration configures the uplink reference signals on the plurality of frequency spectrum bands to be associated with a same antenna port.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with techniques for shared radio frequency communications.

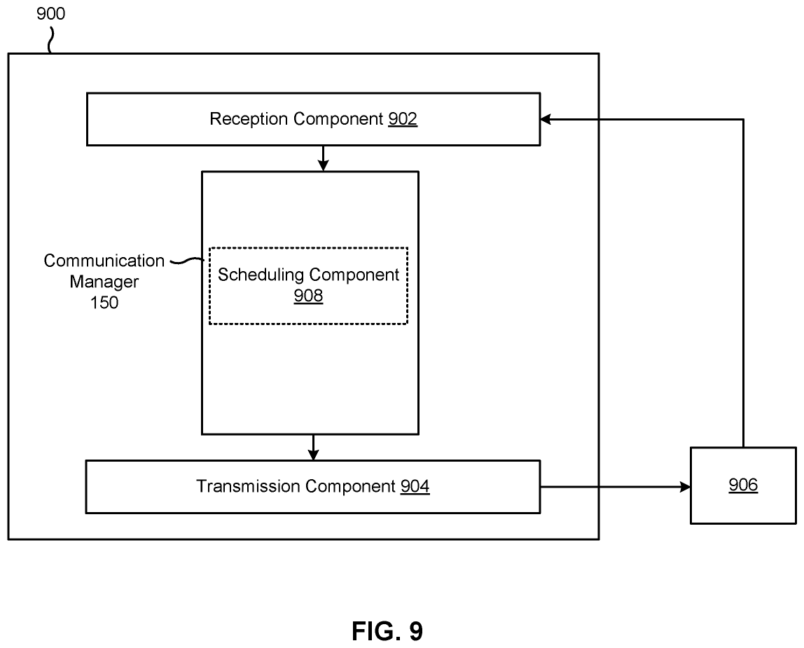

As shown in FIG. 7, in some aspects, process 700 may include receiving, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain (block 710). For example, the base station (e.g., using communication manager 150 and/or reception component 902, depicted in FIG. 9) may receive, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain, as described above.

As further shown in FIG. 7, in some aspects, process 700 may include transmitting, to the UE and based at least in part on the UE capability information, at least one of a measurement configuration associated with downlink reference signals for the plurality of frequency spectrum bands or a transmission configuration associated with uplink reference signals for the plurality of frequency spectrum bands (block 720). For example, the base station (e.g., using communication manager 150 and/or transmission component 904, depicted in FIG. 9) may transmit, to the UE and based at least in part on the UE capability information, at least one of a measurement configuration associated with downlink reference signals for the plurality of frequency spectrum bands or a transmission configuration associated with uplink reference signals for the plurality of frequency spectrum bands, as described above.

Process 700 may include additional aspects, such as any single aspect or any combination of aspects described below and/or in connection with one or more other processes described elsewhere herein.

In a first aspect, the first indication includes an indication of a capability of the UE to receive downlink communications in different frequency spectrum bands of the plurality of frequency spectrum bands without a switching gap between the downlink communications in the different frequency spectrum bands, and the second indication includes an indication of a capability of the UE to transmit uplink communications in the different frequency spectrum bands of the plurality of frequency spectrum bands without a switching gap between the uplink communications in the different frequency spectrum bands.

In a second aspect, alone or in combination with the first aspect, the first indication includes an indication of a capability of the UE to simultaneously receive downlink communications in different frequency spectrum bands of the plurality of frequency spectrum bands, and the second indication includes an indication of a capability of the UE to simultaneously transmit uplink communications in the different frequency spectrum bands of the plurality of frequency spectrum bands.

In a third aspect, alone or in combination with one or more of the first and second aspects, the first indication includes an inter-frequency measurement indication that indicates a capability of the UE for performing inter-frequency SSB based measurements without measurement gaps for SSBs within an active BWP, and the inter-frequency measurement indication further indicates the capability of the UE for downlink reception in the plurality of frequency spectrum bands using the first RF Rx chain.

In a fourth aspect, alone or in combination with one or more of the first through third aspects, the inter-frequency measurement indication indicates that the UE is capable of downlink reception in the plurality of frequency spectrum bands using the first RF Rx chain, and the first indication further includes at least one of an indication of one or more combinations of frequency spectrum bands in the plurality of frequency spectrum bands for which the UE is capable of downlink reception using the first RF Rx chain, or an indication of a frequency range for frequency spectrum bands in the plurality of frequency spectrum bands for which the UE is capable of downlink reception using the first RF Rx chain.

In a fifth aspect, alone or in combination with one or more of the first through fourth aspects, the first indication includes, for each of one or more different combinations of frequency spectrum bands in the plurality of frequency spectrum bands, a respective indication of a capability of the UE for downlink reception in that combination of frequency spectrum bands using the first RF Rx chain.

In a sixth aspect, alone or in combination with one or more of the first through fifth aspects, the second indication includes, for each of one or more different combinations of frequency spectrum bands in the plurality of frequency spectrum bands, a respective indication of a capability of the UE for uplink transmission in that combination of frequency spectrum bands using the second RF Tx chain.

In a seventh aspect, alone or in combination with one or more of the first through sixth aspects, the measurement configuration jointly schedules measurements of the downlink reference signals on the plurality of frequency spectrum bands.

In an eighth aspect, alone or in combination with one or more of the first through seventh aspects, based at least in part on the first indication indicating that the UE is capable of downlink reception in the plurality of frequency spectrum bands using the first RF Rx chain, the measurement configuration jointly schedules the measurements of the downlink reference signals on the plurality of frequency spectrum bands with no measurement gap between the downlink reference signals on different frequency spectrum bands of the plurality of frequency spectrum bands.

In a ninth aspect, alone or in combination with one or more of the first through eighth aspects, the measurement configuration includes a same reference signal configuration for a first downlink reference signal scheduled on a first frequency band of the plurality of frequency spectrum bands and a second downlink reference signal scheduled on a second frequency band of the plurality of frequency spectrum bands.

In a tenth aspect, alone or in combination with one or more of the first through ninth aspects, the transmission configuration jointly schedules transmissions of the uplink reference signals on the plurality of frequency spectrum bands.

In an eleventh aspect, alone or in combination with one or more of the first through tenth aspects, based at least in part on the second indication indicating that the UE is capable of uplink transmission in the plurality of frequency spectrum bands using the second RF Tx chain, the configuration jointly schedules the transmissions of the uplink reference signals on the plurality of frequency spectrum bands with no switching gap between the uplink reference signals on different frequency spectrum bands of the plurality of frequency spectrum bands.

In a twelfth aspect, alone or in combination with one or more of the first through eleventh aspects, the measurement configuration configures the uplink reference signals on the plurality of frequency spectrum bands to be associated with a same antenna port.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a measurement component 808, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The transmission component 804 may transmit, to a base station, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The reception component 802 may receive at least one of a measurement configuration associated with downlink reference signals for the plurality of frequency spectrum bands or a transmission configuration associated with uplink reference signals for the plurality of frequency spectrum bands.

The measurement component 808 may perform measurements of the downlink reference signals.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a scheduling component 908, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a modem, a demodulator, a MIMO detector, a receive processor, a controller/processor, a memory, or a combination thereof, of the base station described in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the base station described in connection with FIG. 2. In some aspects, the transmission component 904 may be co-located with the reception component 902 in a transceiver.

The reception component 902 may receive, from a UE, UE capability information including a first indication of a first capability of the UE for downlink reception in a plurality of frequency spectrum bands using a first RF Rx chain and a second indication of a second capability of the UE for uplink transmission in the plurality of frequency spectrum bands using a second RF Tx chain. The transmission component 904 may transmit, to the UE and based at least in part on the UE capability information, at least one of a measurement configuration associated with downlink reference signals for the plurality of frequency spectrum bands or a transmission configuration associated with uplink reference signals for the plurality of frequency spectrum bands.

The scheduling component may schedule the downlink reference signals in the measurement configuration and/or the uplink reference signals in the transmission configuration based at least in part on the UE capability information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, to a base station, UE capability information including a first indication of a first capability of the UE for downlink reception in a plurality of frequency spectrum bands using a first radio frequency receive chain and a second indication of a second capability of the UE for uplink transmission in the plurality of frequency spectrum bands using a second radio frequency transmit chain; and receiving at least one of a measurement configuration associated with downlink reference signals for the plurality of frequency spectrum bands or a transmission configuration associated with uplink reference signals for the plurality of frequency spectrum bands.

Aspect 2: The method of Aspect 1, wherein the first indication includes an indication of a capability of the UE to receive downlink communications in different frequency spectrum bands of the plurality of frequency spectrum bands without a switching gap between the downlink communications in the different frequency spectrum bands, and wherein the second indication includes an indication of a capability of the UE to transmit uplink communications in the different frequency spectrum bands of the plurality of frequency spectrum bands without a switching gap between the uplink communications in the different frequency spectrum bands.

Aspect 3: The method of any of Aspects 1-2, wherein the first indication includes an indication of a capability of the UE to simultaneously receive downlink communications in different frequency spectrum bands of the plurality of frequency spectrum bands, and wherein the second indication includes an indication of a capability of the UE to simultaneously transmit uplink communications in the different frequency spectrum bands of the plurality of frequency spectrum bands.

Aspect 4: The method of any of Aspects 1-3, wherein the first indication includes an inter-frequency measurement indication that indicates a capability of the UE for performing inter-frequency synchronization signal block (SSB) based measurements without measurement gaps for SSBs within an active bandwidth part (BWP), and wherein the inter-frequency measurement indication further indicates the capability of the UE for downlink reception in the plurality of frequency spectrum bands using the first radio frequency receive chain.

Aspect 5: The method of Aspect 4, wherein the inter-frequency measurement indication indicates that the UE is capable of downlink reception in the plurality of frequency spectrum bands using the first radio frequency receive chain, and wherein the first indication further includes at least one of: an indication of one or more combinations of frequency spectrum bands in the plurality of frequency spectrum bands for which the UE is capable of downlink reception using the first radio frequency receive chain, or an indication of a frequency range for frequency spectrum bands in the plurality of frequency spectrum bands for which the UE is capable of downlink reception using the first radio frequency receive chain.

Aspect 6: The method of any of Aspects 1-3, wherein the first indication includes, for each of one or more different combinations of frequency spectrum bands in the plurality of frequency spectrum bands, a respective indication of a capability of the UE for downlink reception in that combination of frequency spectrum bands using the first radio frequency receive chain.

Aspect 7: The method of any of Aspects 1-6, wherein the second indication includes, for each of one or more different combinations of frequency spectrum bands in the plurality of frequency spectrum bands, a respective indication of a capability of the UE for uplink transmission in that combination of frequency spectrum bands using the second radio frequency transmit chain.

Aspect 8: The method of any of Aspects 1-7, wherein the measurement configuration jointly schedules measurements of the downlink reference signals on the plurality of frequency spectrum bands.

Aspect 9: The method of Aspect 8, wherein, based at least in part on the first indication indicating that the UE is capable of downlink reception in the plurality of frequency spectrum bands using the first radio frequency receive chain, the measurement configuration jointly schedules the measurements of the downlink reference signals on the plurality of frequency spectrum bands with no measurement gap between the downlink reference signals on different frequency spectrum bands of the plurality of frequency spectrum bands.

Aspect 10: The method of any of Aspects 8-9, wherein the measurement configuration includes a same reference signal configuration for a first downlink reference signal scheduled on a first frequency band of the plurality of frequency spectrum bands and a second downlink reference signal scheduled on a second frequency band of the plurality of frequency spectrum bands.

Aspect 11: The method of any of Aspects 1-10, wherein the transmission configuration jointly schedules transmissions of the uplink reference signals on the plurality of frequency spectrum bands.

Aspect 12: The method of Aspect 11, wherein, based at least in part on the second indication indicating that the UE is capable of uplink transmission in the plurality of frequency spectrum bands using the second radio frequency transmit chain, the configuration jointly schedules the transmissions of the uplink reference signals on the plurality of frequency spectrum bands with no switching gap between the uplink reference signals on different frequency spectrum bands of the plurality of frequency spectrum bands.

Aspect 13: The method of any of Aspects 11-12, wherein the measurement configuration configures the uplink reference signals on the plurality of frequency spectrum bands to be associated with a same antenna port.

Aspect 14: A method of wireless communication performed by a base station, comprising: receiving, from a user equipment (UE), UE capability information including a first indication of a first capability of the UE for downlink reception in a plurality of frequency spectrum bands using a first radio frequency receive chain and a second indication of a second capability of the UE for uplink transmission in the plurality of frequency spectrum bands using a second radio frequency transmit chain; and transmitting, to the UE and based at least in part on the UE capability information, at least one of a measurement configuration associated with downlink reference signals for the plurality of frequency spectrum bands or a transmission configuration associated with uplink reference signals for the plurality of frequency spectrum bands.

Aspect 15: The method of Aspect 14, wherein the first indication includes an indication of a capability of the UE to receive downlink communications in different frequency spectrum bands of the plurality of frequency spectrum bands without a switching gap between the downlink communications in the different frequency spectrum bands, and wherein the second indication includes an indication of a capability of the UE to transmit uplink communications in the different frequency spectrum bands of the plurality of frequency spectrum bands without a switching gap between the uplink communications in the different frequency spectrum bands.

Aspect 16: The method of any of Aspects 14-15, wherein the first indication includes an indication of a capability of the UE to simultaneously receive downlink communications in different frequency spectrum bands of the plurality of frequency spectrum bands, and wherein the second indication includes an indication of a capability of the UE to simultaneously transmit uplink communications in the different frequency spectrum bands of the plurality of frequency spectrum bands.

Aspect 17: The method of any of Aspects 14-16, wherein the first indication includes an inter-frequency measurement indication that indicates a capability of the UE for performing inter-frequency synchronization signal block (SSB) based measurements without measurement gaps for SSBs within an active bandwidth part (BWP), and wherein the inter-frequency measurement indication further indicates the capability of the UE for downlink reception in the plurality of frequency spectrum bands using the first radio frequency receive chain.

Aspect 18: The method of Aspect 17, wherein the inter-frequency measurement indication indicates that the UE is capable of downlink reception in the plurality of frequency spectrum bands using the first radio frequency receive chain, and wherein the first indication further includes at least one of: an indication of one or more combinations of frequency spectrum bands in the plurality of frequency spectrum bands for which the UE is capable of downlink reception using the first radio frequency receive chain, or an indication of a frequency range for frequency spectrum bands in the plurality of frequency spectrum bands for which the UE is capable of downlink reception using the first radio frequency receive chain.

Aspect 19: The method of any of Aspects 14-16, wherein the first indication includes, for each of one or more different combinations of frequency spectrum bands in the plurality of frequency spectrum bands, a respective indication of a capability of the UE for downlink reception in that combination of frequency spectrum bands using the first radio frequency receive chain.

Aspect 20: The method of any of Aspects 14-19, wherein the second indication includes, for each of one or more different combinations of frequency spectrum bands in the plurality of frequency spectrum bands, a respective indication of a capability of the UE for uplink transmission in that combination of frequency spectrum bands using the second radio frequency transmit chain.

Aspect 21: The method of any of Aspects 14-20, wherein the measurement configuration jointly schedules measurements of the downlink reference signals on the plurality of frequency spectrum bands.

Aspect 22: The method of Aspect 21, wherein, based at least in part on the first indication indicating that the UE is capable of downlink reception in the plurality of frequency spectrum bands using the first radio frequency receive chain, the measurement configuration jointly schedules the measurements of the downlink reference signals on the plurality of frequency spectrum bands with no measurement gap between the downlink reference signals on different frequency spectrum bands of the plurality of frequency spectrum bands.

Aspect 23: The method of any of Aspects 21-22, wherein the measurement configuration includes a same reference signal configuration for a first downlink reference signal scheduled on a first frequency band of the plurality of frequency spectrum bands and a second downlink reference signal scheduled on a second frequency band of the plurality of frequency spectrum bands.

Aspect 24: The method of any of Aspects 14-23, wherein the transmission configuration jointly schedules transmissions of the uplink reference signals on the plurality of frequency spectrum bands.

Aspect 25: The method of Aspect 24, wherein, based at least in part on the second indication indicating that the UE is capable of uplink transmission in the plurality of frequency spectrum bands using the second radio frequency transmit chain, the configuration jointly schedules the transmissions of the uplink reference signals on the plurality of frequency spectrum bands with no switching gap between the uplink reference signals on different frequency spectrum bands of the plurality of frequency spectrum bands.

Aspect 26: The method of any of Aspects 24-25, wherein the measurement configuration configures the uplink reference signals on the plurality of frequency spectrum bands to be associated with a same antenna port.

Aspect 27: An apparatus for wireless communication at a device, comprising a processor; memory coupled with the processor; and instructions stored in the memory and executable by the processor to cause the apparatus to perform the method of one or more of Aspects 1-13.

Aspect 28: An apparatus for wireless communication at a device, comprising a processor; memory coupled with the processor; and instructions stored in the memory and executable by the processor to cause the apparatus to perform the method of one or more of Aspects 14-26.

Aspect 29: A device for wireless communication, comprising a memory and one or more processors coupled to the memory, the one or more processors configured to perform the method of one or more of Aspects 1-13.

Aspect 30: A device for wireless communication, comprising a memory and one or more processors coupled to the memory, the one or more processors configured to perform the method of one or more of Aspects 14-26.

Aspect 31: An apparatus for wireless communication, comprising at least one means for performing the method of one or more of Aspects 1-13.

Aspect 32: An apparatus for wireless communication, comprising at least one means for performing the method of one or more of Aspects 14-26.

Aspect 33: A non-transitory computer-readable medium storing code for wireless communication, the code comprising instructions executable by a processor to perform the method of one or more of Aspects 1-13.

Aspect 34: A non-transitory computer-readable medium storing code for wireless communication, the code comprising instructions executable by a processor to perform the method of one or more of Aspects 14-26.

Aspect 35: A non-transitory computer-readable medium storing a set of instructions for wireless communication, the set of instructions comprising one or more instructions that, when executed by one or more processors of a device, cause the device to perform the method of one or more of Aspects 1-13.

Aspect 36: A non-transitory computer-readable medium storing a set of instructions for wireless communication, the set of instructions comprising one or more instructions that, when executed by one or more processors of a device, cause the device to perform the method of one or more of Aspects 14-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
transmitting, to a base station, UE capability information including a first indication of a first capability of the UE for downlink reception in a plurality of frequency spectrum bands using a first radio frequency receive chain and a second indication of a second capability of the UE for uplink transmission in the plurality of frequency spectrum bands using a second radio frequency transmit chain; and
receiving at least one of a measurement configuration associated with downlink reference signals for the plurality of frequency spectrum bands or a transmission configuration associated with uplink reference signals for the plurality of frequency spectrum bands.

2. The method of claim 1, wherein the first indication includes an indication of a capability of the UE to receive downlink communications in different frequency spectrum bands of the plurality of frequency spectrum bands without a switching gap between the downlink communications in the different frequency spectrum bands, and wherein the second indication includes an indication of a capability of the UE to transmit uplink communications in the different frequency spectrum bands of the plurality of frequency spectrum bands without a switching gap between the uplink communications in the different frequency spectrum bands.

3. The method of claim 1, wherein the first indication includes an indication of a capability of the UE to simultaneously receive downlink communications in different frequency spectrum bands of the plurality of frequency spectrum bands, and wherein the second indication includes an indication of a capability of the UE to simultaneously transmit uplink communications in the different frequency spectrum bands of the plurality of frequency spectrum bands.

4. The method of claim 1, wherein the first indication includes an inter-frequency measurement indication that indicates a capability of the UE for performing inter-frequency synchronization signal block (SSB) based measurements without measurement gaps for SSBs within an active bandwidth part (BWP), and wherein the inter-frequency measurement indication further indicates the capability of the UE for downlink reception in the plurality of frequency spectrum bands using the first radio frequency receive chain.

5. The method of claim 4, wherein the inter-frequency measurement indication indicates that the UE is capable of downlink reception in the plurality of frequency spectrum bands using the first radio frequency receive chain, and wherein the first indication further includes at least one of:
an indication of one or more combinations of frequency spectrum bands in the plurality of frequency spectrum bands for which the UE is capable of downlink reception using the first radio frequency receive chain, or
an indication of a frequency range for frequency spectrum bands in the plurality of frequency spectrum bands for which the UE is capable of downlink reception using the first radio frequency receive chain.

6. The method of claim 1, wherein the first indication includes, for each of one or more different combinations of frequency spectrum bands in the plurality of frequency spectrum bands, a respective indication of a capability of the UE for downlink reception in that combination of frequency spectrum bands using the first radio frequency receive chain.

7. The method of claim 1, wherein the second indication includes, for each of one or more different combinations of frequency spectrum bands in the plurality of frequency spectrum bands, a respective indication of a capability of the UE for uplink transmission in that combination of frequency spectrum bands using the second radio frequency transmit chain.

8. The method of claim 1, wherein the measurement configuration jointly schedules measurements of the downlink reference signals on the plurality of frequency spectrum bands.

9. The method of claim 8, wherein, based at least in part on the first indication indicating that the UE is capable of downlink reception in the plurality of frequency spectrum bands using the first radio frequency receive chain, the measurement configuration jointly schedules the measurements of the downlink reference signals on the plurality of frequency spectrum bands with no measurement gap between the downlink reference signals on different frequency spectrum bands of the plurality of frequency spectrum bands.

10. The method of claim 8, wherein the measurement configuration includes a same reference signal configuration for a first downlink reference signal scheduled on a first frequency band of the plurality of frequency spectrum bands and a second downlink reference signal scheduled on a second frequency band of the plurality of frequency spectrum bands.

11. The method of claim 1, wherein the transmission configuration jointly schedules transmissions of the uplink reference signals on the plurality of frequency spectrum bands.

12. The method of claim 11, wherein, based at least in part on the second indication indicating that the UE is capable of uplink transmission in the plurality of frequency spectrum bands using the second radio frequency transmit chain, the configuration jointly schedules the transmissions of the uplink reference signals on the plurality of frequency spectrum bands with no switching gap between the uplink reference signals on different frequency spectrum bands of the plurality of frequency spectrum bands.

13. The method of claim 11, wherein the measurement configuration configures the uplink reference signals on the plurality of frequency spectrum bands to be associated with a same antenna port.

14. A method of wireless communication performed by a base station, comprising:
receiving, from a user equipment (UE), UE capability information including a first indication of a first capability of the UE for downlink reception in a plurality of frequency spectrum bands using a first radio frequency receive chain and a second indication of a second capability of the UE for uplink transmission in the plurality of frequency spectrum bands using a second radio frequency transmit chain; and
transmitting, to the UE and based at least in part on the UE capability information, at least one of a measurement configuration associated with downlink reference signals for the plurality of frequency spectrum bands or a transmission configuration associated with uplink reference signals for the plurality of frequency spectrum bands.

15. The method of claim 14, wherein the first indication includes an indication of a capability of the UE to receive downlink communications in different frequency spectrum bands of the plurality of frequency spectrum bands without a switching gap between the downlink communications in the different frequency spectrum bands, and wherein the second indication includes an indication of a capability of the UE to transmit uplink communications in the different frequency spectrum bands of the plurality of frequency spectrum bands without a switching gap between the uplink communications in the different frequency spectrum bands.

16. The method of claim 14, wherein the first indication includes an indication of a capability of the UE to simultaneously receive downlink communications in different frequency spectrum bands of the plurality of frequency spectrum bands, and wherein the second indication includes an indication of a capability of the UE to simultaneously transmit uplink communications in the different frequency spectrum bands of the plurality of frequency spectrum bands.

17. The method of claim 14, wherein the measurement configuration jointly schedules measurements of the downlink reference signals on the plurality of frequency spectrum bands.

18. The method of claim 17, wherein, based at least in part on the first indication indicating that the UE is capable of downlink reception in the plurality of frequency spectrum bands using the first radio frequency receive chain, the measurement configuration jointly schedules the measurements of the downlink reference signals on the plurality of frequency spectrum bands with no measurement gap between the downlink reference signals on different frequency spectrum bands of the plurality of frequency spectrum bands.

19. The method of claim 14, wherein the transmission configuration jointly schedules transmissions of the uplink reference signals on the plurality of frequency spectrum bands.

20. The method of claim 19, wherein, based at least in part on the second indication indicating that the UE is capable of uplink transmission in the plurality of frequency spectrum bands using the second radio frequency transmit chain, the configuration jointly schedules the transmissions of the uplink reference signals on the plurality of frequency spectrum bands with no switching gap between the uplink reference signals on different frequency spectrum bands of the plurality of frequency spectrum bands.

21. A user equipment (UE) for wireless communication, comprising:
a memory; and
one or more processors, coupled to the memory, configured to:
transmit, to a base station, UE capability information including a first indication of a first capability of the UE for downlink reception in a plurality of frequency spectrum bands using a first radio frequency receive chain and a second indication of a second capability of the UE for uplink transmission in the plurality of frequency spectrum bands using a second radio frequency transmit chain; and
receive at least one of a measurement configuration associated with downlink reference signals for the plurality of frequency spectrum bands or a transmission configuration associated with uplink reference signals for the plurality of frequency spectrum bands.

22. The UE of claim 21, wherein the first indication includes an indication of a capability of the UE to receive downlink communications in different frequency spectrum bands of the plurality of frequency spectrum bands without a switching gap between the downlink communications in the different frequency spectrum bands, and wherein the second indication includes an indication of a capability of the UE to transmit uplink communications in the different frequency spectrum bands of the plurality of frequency spectrum bands without a switching gap between the uplink communications in the different frequency spectrum bands.

23. The UE of claim 21, wherein the first indication includes an indication of a capability of the UE to simultaneously receive downlink communications in different frequency spectrum bands of the plurality of frequency spectrum bands, and wherein the second indication includes an indication of a capability of the UE to simultaneously transmit uplink communications in the different frequency spectrum bands of the plurality of frequency spectrum bands.

24. The UE of claim 21, wherein the first indication includes an inter-frequency measurement indication that indicates a capability of the UE for performing inter-frequency synchronization signal block (SSB) based measurements without measurement gaps for SSBs within an active bandwidth part (BWP), and wherein the inter-frequency measurement indication further indicates the capability of the UE for downlink reception in the plurality of frequency spectrum bands using the first radio frequency receive chain.

25. The UE of claim 24, wherein the inter-frequency measurement indication indicates that the UE is capable of downlink reception in the plurality of frequency spectrum bands using the first radio frequency receive chain, and wherein the first indication further includes at least one of:
an indication of one or more combinations of frequency spectrum bands in the plurality of frequency spectrum bands for which the UE is capable of downlink reception using the first radio frequency receive chain, or
an indication of a frequency range for frequency spectrum bands in the plurality of frequency spectrum bands for which the UE is capable of downlink reception using the first radio frequency receive chain.

26. The UE of claim 21, wherein the first indication includes, for each of one or more different combinations of frequency spectrum bands in the plurality of frequency spectrum bands, a respective indication of a capability of the UE for downlink reception in that combination of frequency spectrum bands using the first radio frequency receive chain.

27. The UE of claim 21, wherein the second indication includes, for each of one or more different combinations of frequency spectrum bands in the plurality of frequency spectrum bands, a respective indication of a capability of the UE for uplink transmission in that combination of frequency spectrum bands using the second radio frequency transmit chain.

28. The UE of claim 21, wherein the measurement configuration jointly schedules measurements of the downlink reference signals on the plurality of frequency spectrum bands.

29. The UE of claim 21, wherein the transmission configuration jointly schedules transmissions of the uplink reference signals on the plurality of frequency spectrum bands.

30. A base station for wireless communication, comprising:
a memory; and
one or more processors, coupled to the memory, configured to:
receive, from a user equipment (UE), UE capability information including a first indication of a first capability of the UE for downlink reception in a plurality of frequency spectrum bands using a first radio frequency receive chain and a second indication of a second capability of the UE for uplink transmission in the plurality of frequency spectrum bands using a second radio frequency transmit chain; and
transmit, to the UE and based at least in part on the UE capability information, at least one of a measurement configuration associated with downlink reference signals for the plurality of frequency spectrum bands or a transmission configuration associated with uplink reference signals for the plurality of frequency spectrum bands.
